(19) United States
(12) Patent Application Publication
(10) Pub. No.: US 2019/0113679 A1
(43) Pub. Date: Apr. 18, 2019

(54) ULTRA-SHORT PULSE LASER LIGHT GUIDE CABLE

(71) Applicant: HIGHYAG Lasertechnologie GmbH, Kleinmachnow (DE)

(72) Inventor: Tobias Schwarz, Potsdam (DE)

(21) Appl. No.: 16/158,637

(22) Filed: Oct. 12, 2018

(30) Foreign Application Priority Data
Oct. 12, 2017 (LU) 100495

(51) Int. Cl. G02B 6/02; G02B 6/42

(52) U.S. Cl. CPC G02B 6/02328; G02B 6/264; G02B 6/4206; G02B 6/4296

(57) ABSTRACT

A hollow body for light guide cable for ultrashort pulse laser, which is characterized by a spherical shape and a bore for the insertion of an light guide fiber. Hollow body and hollow core fiber can be evacuated prior to bonding and/or filled with a gas at a defined pressure. The two hollow bodies are gas-tightly connected to the optical fiber.

### CROSS REFERENCES TO RELATED APPLICATIONS

The present application claims priority to Luxembourg Patent Application No. LU 100495 filed on Oct. 12, 2017. The aforementioned application is hereby incorporated by reference in its entirety.

### BACKGROUND OF THE INVENTION

### Field of the Invention

The invention relates to an end cap for ultrashort pulse (USP) light guide cable and a light-guide cable with corresponding end caps and a method for their manufacture.

### Brief Description of the Background Art

Laser beam sources which emit pulsed laser light with pulse durations in the range of femtoseconds to picoseconds are referred to as ultrashort pulse lasers (USP) allowing wave-lengths in the UV and even NIR range. They further allow propagation processes that are not possible with conventional tools. With the concentrated energy of the laser pulses, materials can be processed quickly, precisely and in large quantities.

USP radiation is currently transmitted as a free jet or in an evacuated/gas-filled light guide cable (LGC). In addition to mere beam transport, hollow core fiber technology offers new possibilities for adapting the pulses. Through targeted control of nonlinear effects, it is possible to achieve pulse compression. In this case, a self-phase modulation of the laser pulse is induced within the fiber. By controlling the gas pressure within the laser light cable, the resulting spectral broadening and the induced pulp pitch can be accurately adjusted and subsequently compressed with an external compressor. It is thus possible to change the pulse duration over a very wide range of pulse parameters. Compression factors of 3 to 10 can be achieved so that a 1 ps pulse can be compressed to a few 100 fs.

A disadvantage of gas-filled light guide cable is the fact that they must be permanently checked in order to ensure the achieved beam properties or to be able to reach by evacuating or filling the optical fiber cable at all. The filling of a hollow core fiber with air leads to a pulse and spectral expansion, the ionization threshold is low and therefore they are not suitable for high pulse energies. If a hollow core fiber is filled with a noble gas, this also leads to a pulse and spectral expansion, but with a high ionization threshold, which brings a suitability for high pulse energies. Thus, solutions known from the prior art are related to a high design effort in monitoring the optical fiber.

In addition, care must be taken to ensure that these special light guide cables are also provided with appropriate connections, since gas pressures of up to 50 bar are used. In this context, the safety of the connections of optical cables has to be considered.

French published patent application No. FR 3039289A1 discloses that an end cap with a long optical path is destroyed because of the temporal and spatial high photon density of the ultrashort pulse laser, the absorption mechanism of transparent materials changes.

In the published American patent application No. US 2009/0188901 A1 thin, planar optical elements for gas-tight closure of the glass capillary are disclosed with a one-set pressure, whereby the radiation properties are not adaptable.

Published German patent application No. DE 102016116409 A1 technical arrangements are known in which the hollow core fiber terminates in the plug, which in turn is sealed gas-tight. The plug and thus the hollow core fiber can be evacuated and filled with gas. As a result, the jet properties of the fiber can also be subsequently changed. The disadvantage of this is that the print parameters must be permanently checked and, if necessary, adjusted. Both variants make it possible to use conventional flat glass substrates which have to be irradiated by the USP. However, a transmission of planar glass substrates leads to an opening defect which, when irradiated with ultrashort laser pulses, has a particularly disadvantageous effect, since pulse expansion occurs here.

Published European patent application No. EP 2 056 144 A1 discloses the use of solid end caps which have a spherical surface in their optically active area in order to minimize this error. However, this technology is not applicable to USP laser radiation due to the high energy density. Here, the same effects will occur as in the fiber piece disclosed in FR 3039289 A1; finally, the absorption would destroy the fiber optic cable.

Published European patent application No. EP 2 309 609 A2 describes an optical arrangement in which a gas-filled hollow core fiber is arranged between optical fibers. In this case, the gas-filled part is spliced between the optical fibers by suitable methods after it has been evacuated and filled with a desired gas. The optical device described in EP 2 309 609 A2 is not suitable as a light guide cable for transmitting high pulse energies, since the gas-filled part is flanked by non-gas-filled optical fibers. These would be destroyed immediately when high pulse energies are coupled in.

It is an object of the present invention to provide an end cap for a light guide cable, which minimizes aperture errors and may find application for USP laser radiation.

### SUMMARY OF THE INVENTION

The object of the invention is solved by the features of the independent claims. According to the invention, this object is achieved in that by the spherically curved end cap the optimal coupling and/or coupling without wave front distortions in USP light guide cables is made possible.

The object of the invention is solved by the features of the independent claims. According to the invention, this object is achieved in that the optimal coupling and/or decoupling without wavefront distortions in UKP light guide cable is made possible by the spherically curved end cap.

The present invention provides an end cap for light guide cables for ultrashort pulse lasers, wherein the at least one end cap is an optical element, with at least one curved optical surface. An optical surface or an optically effective region means an area through which laser light is guided.

It is provided in a further embodiment of the end cap that the radius of curvature consists of a partial sphere, wherein the spherical surface is limited at least to the curved optical surface.

Furthermore, an end cap is provided according to the invention, in which the radius of curvature corresponds to a meniscus lens whose respective surface comprises at least the curved optical surface.

The invention further provides an end cap, wherein the radius of curvature of the curved optical surface is in a range between 2 mm to 30 cm.

In a further embodiment of the end cap according to the invention, the wall thickness of the curved optical surface may be in a range between 0.3 mm to 3 mm.

For the curved optical surface of the end cap it is provided that it may consist of an optically transparent material, wherein the optically transparent material may be quartz glass.

Another aspect of the present invention relates to a light guide cable for ultra-short pulsed laser, which consists over its entire course of a hollow core fiber and the hollow core is filled with a gas at a defined pressure, and the two ends of the light-conducting cable are sealed gas-tight by an end cap as described above.

For the light guide cable according to the invention it is further provided that the end of the hollow-core fiber may be arranged in the center of the circle, which is defined by the radius of the curved optical surface or may be on the radius of the circle arranged between the center of the circle and its circumference.

An optical cable according to the invention may have end caps at both ends with different radii at the respective curvatures and/or different wall thicknesses of the curved optical surfaces.

An optical cable according to the invention may have end caps at both ends with the same radii at the respective curvatures and/or different wall thicknesses of the curved optical surfaces.

Furthermore, it is provided that the end caps at both ends may have the same radii at the respective curvatures and different centers of the curved optical surfaces, resulting in a meniscus lens.

Another object of the present invention is a manufacturing method for a light guide cable for ultrashort pulse laser, as described above, comprising the steps;
a. Providing a hollow core fiber;
b. Providing two end caps as previously described for each end of the hollow core fiber; and
c. Gas tight connection of the end caps to the ends of a hollow core fiber.

The method provides that the end of the hollow core fiber can be arranged in the center of the circle, which is defined by the radius of the curved optical surface of the end cap or may be arranged on the radius of the circle between the center of the circle and its circumference.

According to the invention, the end caps and the hollow core fiber can be evacuated and/or filled with a gas at a defined pressure before joining.

The invented method further provides the connection of end caps and hollow core fiber in an evacuated space.

The invention also relates to the use of an end cap as described above and/or a light guide cable as described above in the laser material processing with an ultrashort pulse laser.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE FIGURES

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention. It shows:

FIG. 1 is a representation of a spherical optical element in the input/output plane.

FIG. 2 is a representation of an optical element in which the input/output surface is designed spherically.

FIG. 3 is a representation of an optical element in which the coupling/decoupling surface is designed as a spherical meniscus lens.

FIG. 4 is a wavefront error plane coupling surface (top), meniscus-shaped coupling surface (lying on the axis) and spherical coupling surface (bottom).

FIG. 5 is a wavefront error plane coupling surface.

FIG. 6 is a wavefront error spherical coupling surface.

FIG. 7 is a wavefront error meniscus lens-shaped coupling surface.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

The present invention provides a light guide cable for ultra-short pulse laser available, which consists over its entire course of a hollow core fiber and end caps and the hollow core and the end caps are filled with a gas at a defined pressure, and the two ends of the optical cable are sealed gas-tight by first and second end cap.

When optimum transmission conditions for ultrashort pulse lasers are known, the essential advantage of the present invention is that the optical fiber cable does not have to be permanently evacuated or filled. Monitoring the gas pressure is also redundant. Rather, the invention makes use of the fact that both the medium for filling the hollow core fiber and the required pressure can be set in relation to the desired transmission properties. This makes it possible to produce preconfigured light guide cables, in which the design complexity is reduced in their use.

If the pressure drops in gas-filled cables from the prior art, a burning of the optical fiber cable results, so that the production process has to be interrupted, because the cable must be replaced. In addition to the replacement, a new light guide cable from the prior art has to be evacuated and possibly refilled with a gas. Subsequently, the pressure in the hollow core of the optical fiber must be adjusted again as required for the respective production process. All these measures are accompanied by a long production stoppage.

In addition to the higher process reliability, optical fiber cables according to the present invention also offer the same and constant properties in laser beam transmission. The adjustment can be made prior to the use of the optical fiber cable, so that the production process is independent of this process.

The risk of light guide cable contamination during monitoring and calibration during the ongoing production process is also reduced through the use of cables that can be preconfigured under clean room conditions.

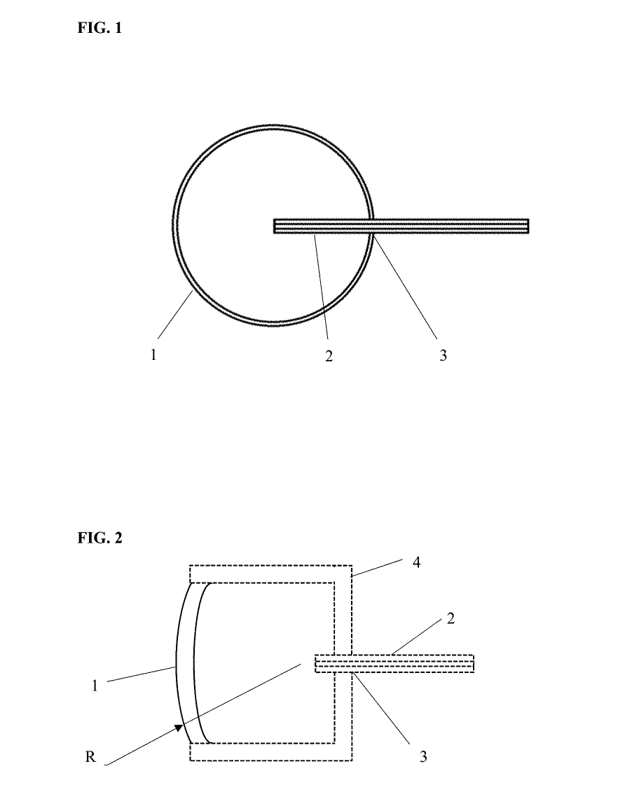

FIG. 1 shows the connection of an optical element 1 which is spherical in the input and outcoupling plane with a hollow core fiber 2 as an optical fiber. The joints 3 serve to seal the construct.

FIG. 2 shows the connection of a cylindrical optical element 4 with a spherical input and output surface 1 and with a hollow core fiber 2 as an optical fiber. The connection points 3 serve to seal the construct.

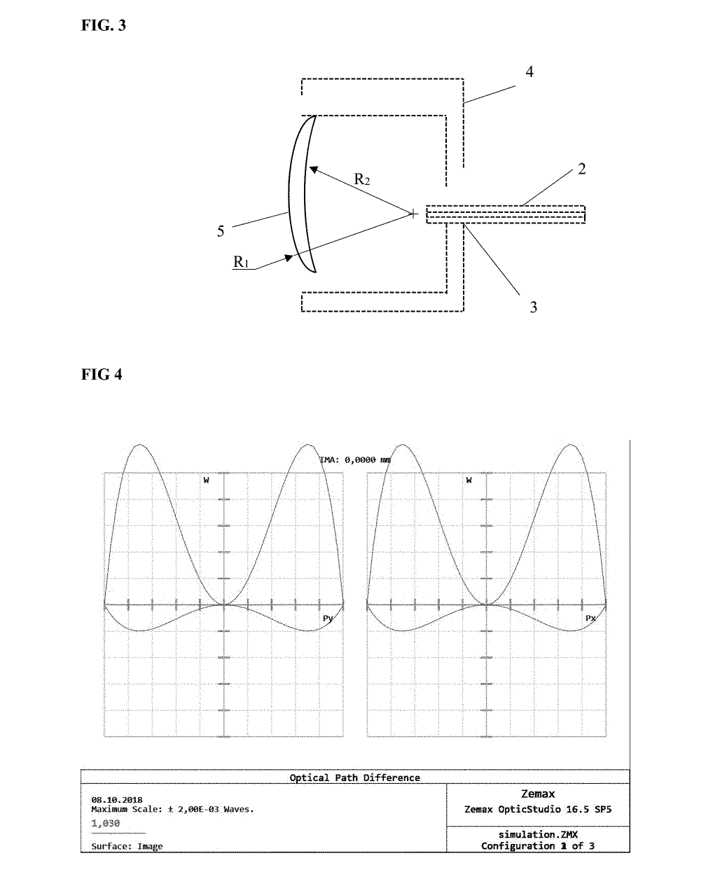

FIG. 3 shows the connection of a cylindrical optical element 4 with a spherical input and outcoupling surface (meniscus lens) 5 and with a hollow core fiber 2 as an optical fiber. The joints 3 serve to seal the construct.

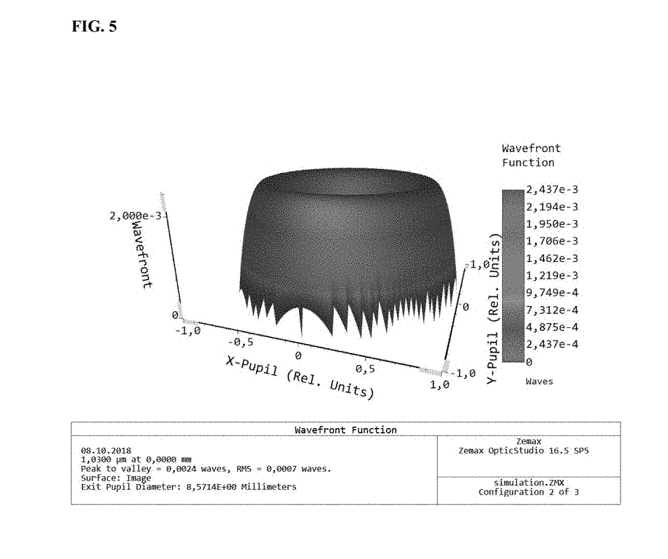

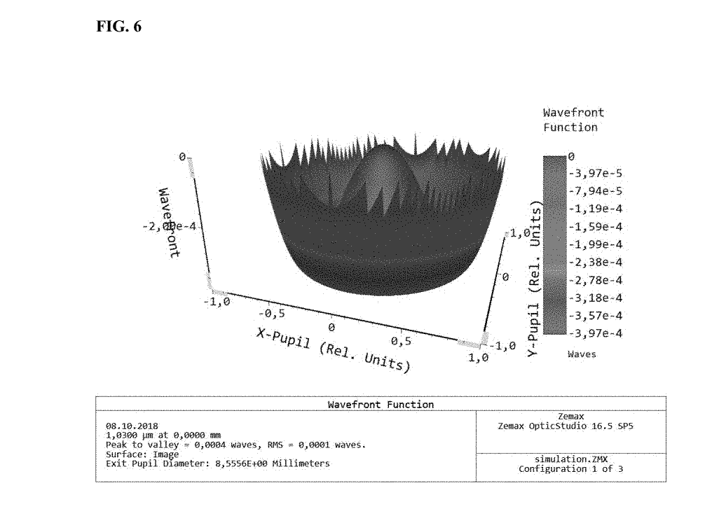

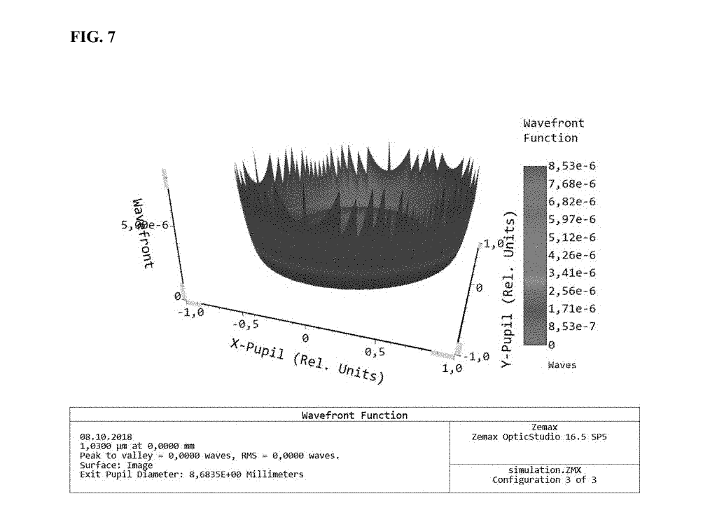

From the results illustrated in FIGS. 4-7, provided that the optimum transmission conditions for ultra-short pulse laser are known, the advantage of the described invention is that the wavefront distortions can be miniaturized by a factor of about 70 by the special shaping of the end cap, which improves the imaging properties and minimizes pulse expansion compared to a planar substrate. This effect is obvious when taking a look to the attached simulation in FIGS. 5-7.

Another advantage of the invention is that the light guide cable does not have to be permanently evacuated or filled, allowing a durable efficient use. Monitoring the gas pressure is also superfluous. Rather, the invention makes use of the fact that both the medium for filling the hollow core fiber and the required pressure can be set in relation to the desired transmission properties. This makes it possible to produce preconfigured light guide cables, in which the design complexity is reduced in their use.

The invention relates to a hollow body for optical fiber cable for ultrashort pulse laser, which is characterized by a spherical shape and a hole for inserting an light guide fiber. Hollow body and light guide fiber can be evacuated prior to bonding and/or filled with a gas at a defined pressure. The two hollow bodies are gas-tightly connected to the optical fiber. The connection can be made in an evacuated room.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

### REFERENCE NUMERALS

1 spherical optical element, end cap
2 hollow core fiber
3 joints
4 cylindrical optical element
5 meniscus lens

1. An end cap for light guide cable for ultrashort pulse laser, wherein the at least one end cap is an optical element with at least one curved optical surface.

2. The end cap of claim 1, wherein the radius of curvature of the curved optical surface consists of a partial sphere, wherein the spherical surface is limited at least to the curved optical surface.

3. The end cap of claim 1, wherein the radius of curvature corresponds to a meniscus lens whose respective surface comprises at least the curved optical surface.

4. The end cap of claim 1, wherein the radius of curvature of the curved optical surface is in a range between 2 mm to 30 cm.

5. The end cap of claim 1, wherein the wall thickness of the curved optical surface may be in a range between 0.3 mm to 3 mm.

6. The end cap of claim 1, wherein the curved optical surface consists of an optically transparent material.

7. The end cap of claim 6, wherein the optically transparent material may be quartz glass.

8. A light guide cable for ultra-short pulsed laser, which consists over its entire course of a hollow core fiber and the hollow core is filled with a gas at a defined pressure, and the two ends of the light guide cable are sealed gas-tight by an end cap according to claim 1.

9. The light guide cable of claim 8, wherein the end of the hollow-core fiber is arranged in the center of the circle, which is defined by the radius of the curved optical surface or is arranged on the radius of the circle between the center of the circle and its circumference.

10. The light guide cable of claim 8, wherein end caps have at both ends different radii at the respective curvatures and/or different wall thicknesses of the curved optical surfaces.

11. The light guide cable of claim 8, wherein end caps have at both ends the same radii at the respective curvatures and/or different wall thicknesses of the curved optical surfaces.

12. The light guide cable of claim 8, wherein the end caps at both ends have the same radii at the respective curvatures and/or different wall thicknesses of the curved optical surfaces.

13. A manufacturing method for a light guide cable for ultrashort pulse laser, as described above, comprising the steps;
a. providing a hollow core fiber;
b. providing two end caps according to claim 1 for each end of the hollow core fiber; and
c. gas tight connection of the end caps to the ends of a hollow core fiber.

14. The method of claim 13 wherein the end of the hollow core fiber is arranged in the center of the circle, which is defined by the radius of curvature of the curved optical surface of the end cap or is arranged on the radius of the circle between the center of the circle and its circumference.

15. A method of claim 13, wherein the end caps and the hollow core fiber are evacuated and/or filled with a gas at a defined pressure before joining.

16. The method according to claim 13, wherein end caps and hollow core fiber are connected in an evacuated space.

17. A method of use of an end cap of claim 1 in the laser material processing with an ultrashort pulse laser.
